(19) United States
(12) Patent Application Publication
(10) Pub. No.: US 2017/0358952 A1
(43) Pub. Date: Dec. 14, 2017

(54) Method and Process for a Smart Door System

(71) Applicants: Edward Butler, Gilbert, AZ (US); Paul Scott Levy, Chandler, AZ (US)

(72) Inventors: Edward Butler, Gilbert, AZ (US); Paul Scott Levy, Chandler, AZ (US)

(21) Appl. No.: 15/179,917

(22) Filed: Jun. 10, 2016

(51) Int. Cl. H02J 50/12; E06B 3/70; E06B 3/04; E05B 47/00; E06B 7/28; H02J 7/00; G08B 3/10

(52) U.S. Cl. CPC H02J 50/12; H02J 7/0052; E06B 3/70; G08B 3/10; E05B 47/00; E06B 7/28; E06B 3/04; E05B 2047/0084

(57) ABSTRACT

Doors provide the means of access to a room or building. Enhancing the functionality of doors today requires ad-hock means for security and or communication. Both of these require a source of electrical power to operate these systems. Security is enabled using either mechanical locking devices, electro-mechanical locks, or magnetic locks. Communication is enabled using a variety of methods from metal striking devices, to push button voice systems, to video cameras. These systems require electrical power by either the use wires and or batteries. The invention describes a method and process for providing power to doors wirelessly.

### FIELD OF THE INVENTION

The present invention relates the wireless power distribution and wireless communication.

### BACKGROUND

Adding Smart functions to entry doors use ad-hock methods, leveraging aftermarket systems such as electronic locks, cameras, and mics. These systems all require power and communication. Power is provided using umbilical cabling between the door and the door frame or batteries contained within the device or a combination of both. Communication is typically wireless, leveraging existing home Wi-Fi networking and or near field communications, such as, Bluetooth with a smartphone or other electronic key. Batteries used in such application are of the disposable type, not rechargeable.

### SUMMARY OF THE INVENTION

In accordance with one aspect of the invention, there is provided a wireless connection between the Door and the Door Frame as a means of transmitting power leveraging coils that transmit power from the Door Frame coil (Power Transfer Unit) to the Door Coil (Power Receive Unit).

In accordance with another aspect of the invention, there is provided a means to mount the Power Transfer Unit to the Door frame such that the transmitting surface of the Power Transfer Unit is within proximity of the Power Receive Unit when the Door is in the closed position.

In accordance with another aspect of the invention, there is provided a means to integrate the Power Transfer Unit Resonator into the sleeve of the door locking mechanism, and the Power Receive Unit Resonator into the bolt of the door locking mechanism.

In accordance with another aspect of the invention, there is provided a means to integrate the Power Transfer Unit Resonator into the door strike plate of the door locking mechanism, and the Power Receive Unit Resonator into the door frame plate of the door locking

In accordance with another aspect of the invention, there is provided a means to mount the Power Receive Unit to the Door such that the receiving surface of the Power Receive Unit is within proximity of the Power Transfer Unit when the Door is in the closed position so power can be transmitted and received between the Power Transfer Unit and the Power Receive Unit.

In accordance with another aspect of the invention, an external power source is connected to the Power Transfer unit so the power can be transformed for the purpose of transmitting power to the Power receive unit and for the electronic control needed to perform such transformation.

In accordance with another aspect of the invention, an external rechargeable or non-rechargeable battery or other means employed to store power is connected to the Power Receive Unit as a means to supply power to electronic functions located in the Door and maintaining the charging of said battery. When the distance between Power Transfer Unit and the Power Receive Unit is less than or equal to the maximum spacing specification for power transfer, power is transferred between the Power Transfer Unit and the Power Receive Unit, powering and/or storing power to the rechargeable or non-rechargeable battery for use by the attached electronic device. When the proximity between the Power Transfer Unit and the Power Receive Unit exceeds the maximum distance specification for power transfer the attached electronic device is powered by the rechargeable battery or non-rechargeable battery.

In accordance with another aspect of the invention, the Power Receive Unit is the only means to supply power to electronic functions located in the Door. When the distance between Power Transfer Unit and the Power Receive Unit is less than or equal to the maximum spacing specification for power transfer, power is transferred between the Power Transfer Unit and the Power Receive Unit, powering the attached electronic device. When the proximity between the Power Transfer Unit and the Power Receive Unit exceeds the maximum distance specification for power transfer the attached electronic device is not powered.

In accordance with another aspect of the invention, in-band communication via PTU/PRU coils and/or out of band communication via Bluetooth when exercising the specification can be utilized to communicate, for example, battery charging requirements, charging statistics, and other related statistics and metrics.

In accordance with another aspect of the invention, a standard door bell circuit is modified to provide continuous power within close proximity to the Power Transfer Unit. The circuit modification requires removal of the existing Door Bell, bridging the removed wire together so all devices on this new circuit are directly connected with the existing Door Bell transformer or a higher power replacement transformer driving this circuit. The existing Door Bel Switch also needs to be replaced with a Door Bell Transmitter switch device. The replacement Door Bell is controlled by a radio receiver which is paired to the new Door Bell Transmitter switch. This arrangement restores the door bell function while providing continuous power to the Power Transfer Unit by extending the low voltage wiring from the Door Bell switch transmitter that has local proximity to the Power Transfer Unit located in the door frame.

### BRIEF DESCRIPTION OF THE FIGURES

Other aspects and advantages of the invention will become apparent upon reading the following detailed description and upon reference to the drawings in which:

FIG. 1. Is a functional block diagram illustrating the components that comprise the Power Transfer Unit, the Power Receive Unit and method for wireless transmission power between the Power Transfer Unit and the Power Receive Unit

FIG. 2. Is a more detailed functional block diagram illustrating the Power Transfer Unit coupled to an Bluetooth communication port, the Power Receive Unit, with a optional rechargeable battery supply system, supporting a keyless entry device using an integrated Bluetooth communication, a MCU with out of band wireless, connecting the Bluetooth port 261 to Bluetooth Port 232.

FIG. 3. Is a block diagram of sample implementation of an entry Door with placement of the Power Transfer Unit, Power receive Unit with an optional rechargeable battery, entry camera and an alternate keyless entry device.

FIG. 4. A block diagram of the integration of the Power Transfer Unit Resonator into the sleeve of the door locking mechanism, and the Power Receive Unit Resonator into the bolt of the door locking mechanism.

FIG. 5. A block diagram of the integration of the Power Transfer Unit Resonator into the door strike plate of the door locking mechanism, and the Power Receive Unit Resonator into the door frame plate of the door locking

FIG. 6A. A block diagram of existing typical electrical door bell installations that includes a step down transformer, door bell ringer, and switch.

FIG. 6B. A block diagram of existing typical electrical door bell installations that includes a step down transformer, door bell ringer, and switch with modification showing reconfiguration to power the Power Transfer Unit in a door jam.

### DETAILED DESCRIPTION OF THE INVENTION

In the following detailed description numerous specifics are set forth in order to provide a thorough understanding of the present invention. However, the present invention may be used without understanding many of these specific details.

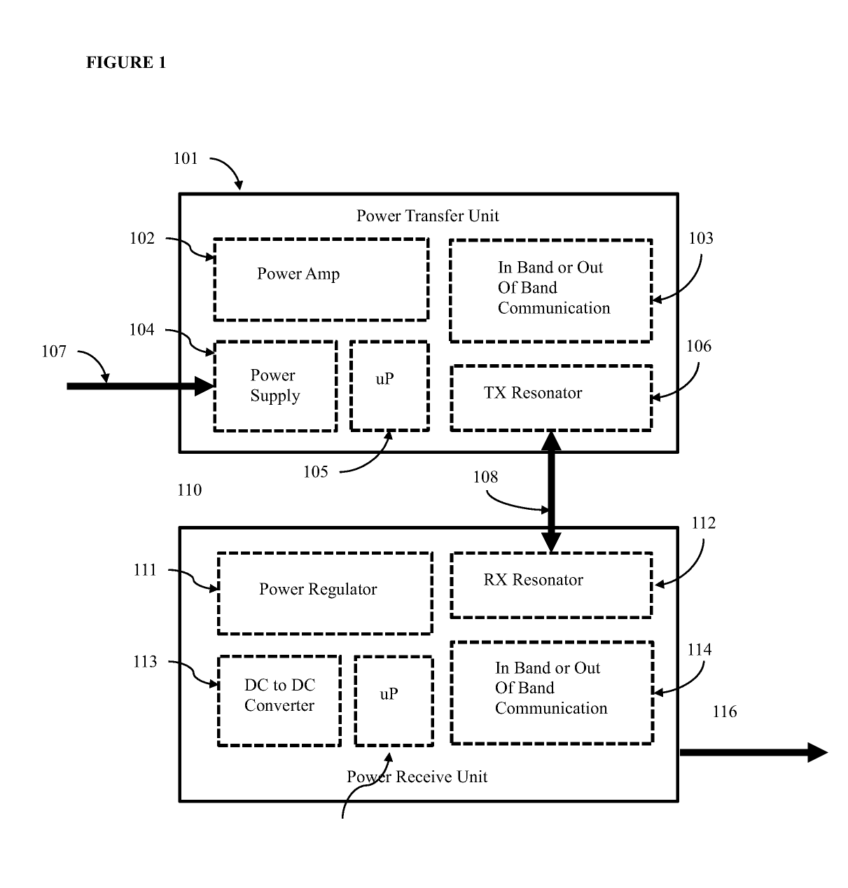

Referring to drawings, FIG. 1 illustrates the basic components of a wireless power transfer system comprised of two components. One component the Power Transfer Unit 101 receives its power thru cable 107 into power supply 104 that supplies power for the rest of the functional blocks within the Power Transfer Unit. Operational management from a micro-processor 105 controls state of the power amp 102 which generates high frequency energy into the TX Resonator 106. Communication needed for various feedback information is accommodated by the Communication block 103 using in-band thru the TX Resonator or out of band using Bluetooth.

The other component is the Power Receive Unit 110 which get its power from the RX Resonator 112 from the radiated energy form TX Resonator 106 via electromagnetic coupling 108. The power from the RX Resonator is managed by the Power Regulator 111 and sent to the DC to DC converter 113 which provides power for the Micro-Processor 115 that manages the Power Receive Units Communication function 114 in order to provide the feedback path to the Power Transfer Unit 101 for the purpose of increasing or decreasing power emanating from TX Resonator 106. The output power of the PRU is via connector 116.

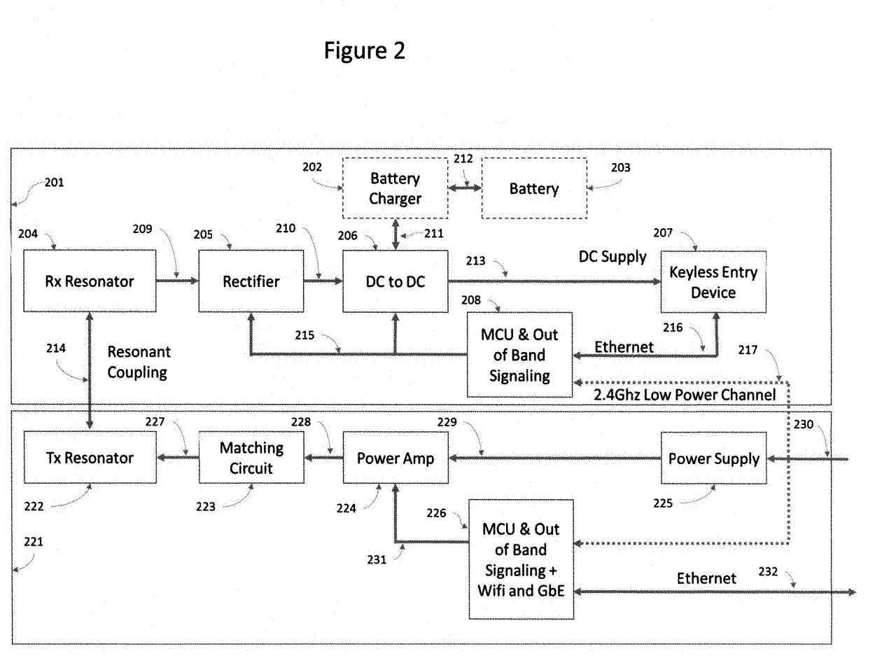

FIG. 2 illustrates in more detail the functional blocks that make up the Power Transfer Unit previously described in FIG. 101 with the additional capability of a hard ware communication function, Bluetooth, combined into the Micro-Processor block 226. This illustration shows the Keyless Entry function connected to the Power Receive Unit 201's Micro-Processor 208 for the purpose of sending and receiving information vis wireless channel 217 which then connects to the hardware Bluetooth 232 thru the Power Transfer Unit 221's Micro-compressor 226.

Furthermore, FIG. 2 illustrates an optional rechargeable Battery 203 which supplies power to the Keyless entry device 207 via an optional Battery Charger 202 coupled to DC to DC converter 231.

Furthermore, FIG. 2 illustrates a optional rechargeable Battery 203 is recharged from energy received by the Rx Resonator 204 coupled to Rectifier 205 which is coupled to DC to DC converter 206 which supplies power to an optional Battery Charger 202.

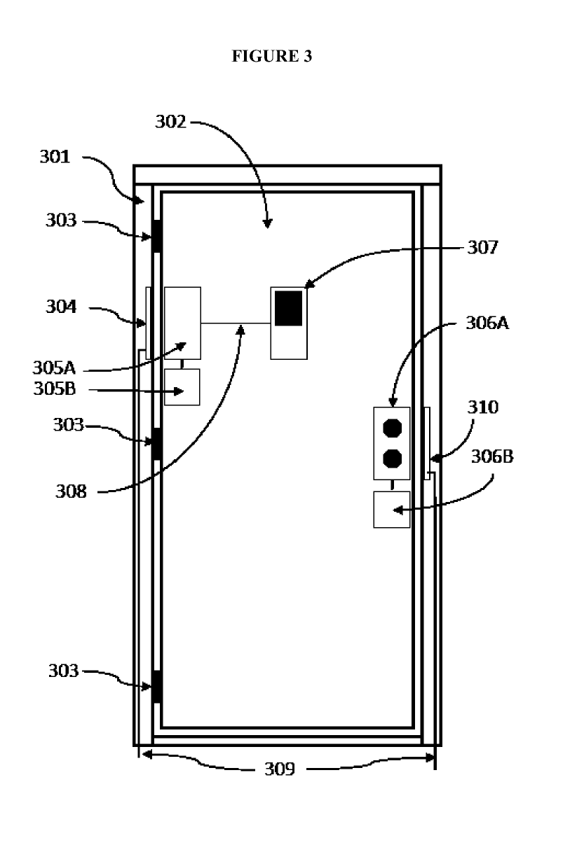

FIG. 3 illustrates a sample implementation if an Entry Door 302 hung in Door Frame 301 using hinges 303. This sample representation of an entry camera is shown as 307 is connected to Door 302 and receives its power from Power Receive Unit 305A and the associated optional rechargeable Battery 305B both of which is placed within a hollowed out cavity of Door 302. The power to charge the optional rechargeable Battery and also power the Power Receiving Unit 305A is supported by the Power Transfer Unit 304 shown here in a cavity in the Frame such that when the door is in the closed position the TX Resonator of the Power Transfer Unit 304 is in close proximity of the RX Resonator of the Power Receive Unit 305A.

FIG. 3 also illustrates a Keyless entry power and communication method where the Keyless Entry mechanism is combined with the Power Receive Unit 306A that receives operating power from Power Transfer Unit 310 that can be combined with the Keyless Lock striker. An optional rechargeable Battery 306B may be used to power the Keyless entry module 306A when the door is open. In each case the Power Transfer Unit 310 is supplied power from the outside using AC current 309. In the case where no battery is used, the keyless entry module 306A loses power and becomes un-operational when the door 302 is open, when the door 302 is closed the keyless entry module 306A powers up and resumes its normal operational state.

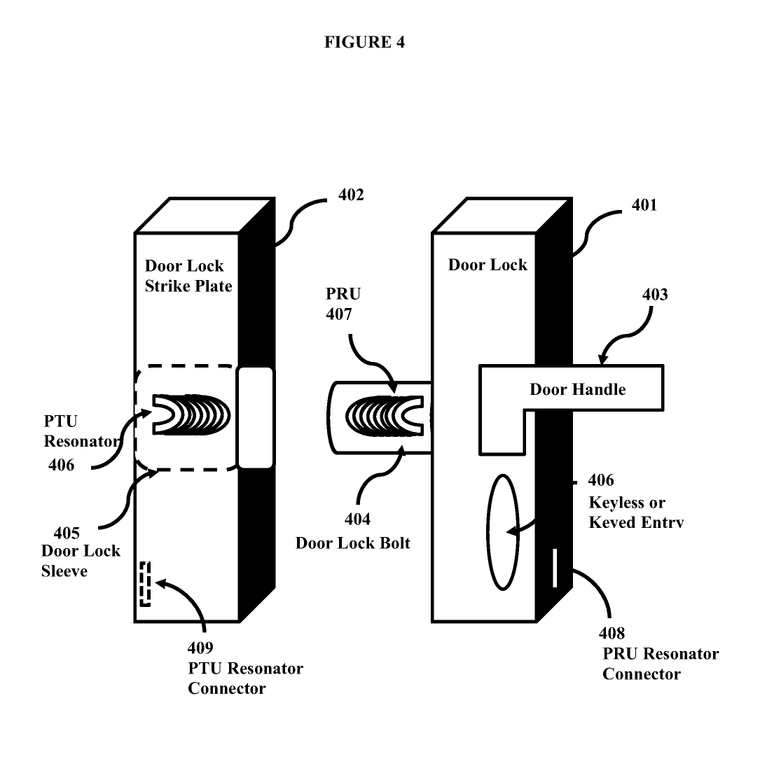

FIG. 4 illustrates the PTU resonator 406 integration into the door lock strike plate 402 sleeve 405. The PRU resonator 407 is integrated into the door lock 401 lock bolt 404. The lock bolt 404 is inserted into the door lock sleeve 405 via the function of the keyless or keyed entry 406 control. When this event occurs the PTU Resonator 406 provides power to the PRU Resonator 407. PTU Resonator connector 409 provides the electrical connection to the PTU Resonator 406. PRU Resonator connector 408 provides the electrical connection to the PTU Resonator 407. In the case where both the Door Lock 401 and Door Lock strike plate 402 have the required physical area, the complete PTU 101 and the complete PRU 110 can be integrated respectively in the associated Door Lock 401 and Door Lock strike plate 402. PTU Resonator connector 409 and PRU Resonator connector 408 can then be used for the electrical connection 107 and 116 respectively.

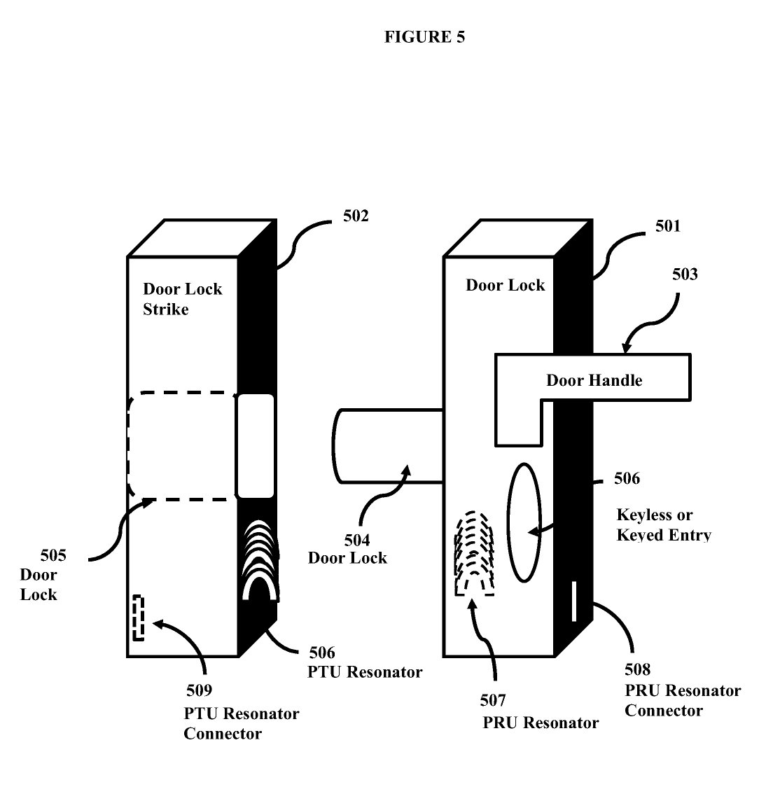

FIG. 5 illustrates the PTU resonator 506 integration into the Door Lock Strike plate 502. The PRU resonator 507 is integrated into the Door Lock 501. When the door is closed, Door Lock 501 mates with Door Lock Strike Plate 502. When this event occurs the PTU Resonator 506 provides power to the and PRU Resonator 507. PTU Resonator connector 509 provides the electrical connection to the PTU Resonator 506. PRU Resonator connector 508 provides the electrical connection to the PTU Resonator 507. In the case where both the Door Lock 501 and Door Lock strike plate 502 have the required physical area, the complete PTU 101 and the complete PRU 110 can be integrated respectively in the associated Door Lock 501 and Door Lock strike plate 502. PTU Resonator connector 509 and PRU Resonator connector 508 can then be used for the electrical connection 107 and 116 respectively

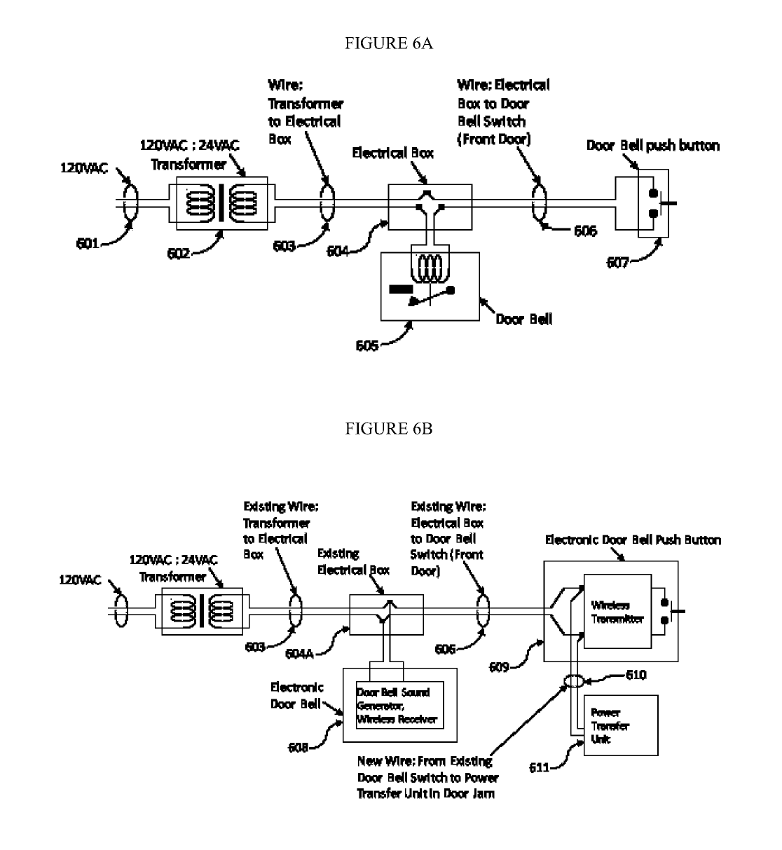

FIG. 6A illustrates a typical door bell wiring scheme used in most existing houses. AC transformer 602 is powered by house current 601. Low voltage wiring 603 is routed to an electrical junction box 604 centrally located in the house. A second low voltage wire 606 is routed from the electrical box 604 to a location next to a door. A door bell push button 607 is attached to the end of low voltage wire 606. A door bell 605 is attached connect to the wiring shown in electrical box 604. The Electrical current flows through the Door Bell when the Door Bell Push Button is closed, completing the circuit causing the door bell to ring.

Because of the physical proximity between the Door Bell Switch and the Door, it is desirable to use this existing wiring 603 and 606. The circuit modification is shown in FIG. 6B electrical box 604A. The addition of low voltage wires 610 are routed from the existing Door Bell switch to the location of the PTU resonator located in the door jam of an existing door extending the ability of the existing transformer 602 to power the PTU resonator. Circuit modification in Electrical box 604A enables continuous current from transformer 602 to be available to PTU. Door Bell function is restored by using the existing wiring, which now provides continuous current to any device attached across this circuit.

To restore the Door Bell function, as shown in FIG. 6B, an electronic door bell 608 is powered by the existing wiring. Electronic Door Bell 608, which contains wireless receiver, receives a wireless activation signal from Electronic Door Bell Push Button which contains a wireless transmitter 609 which is powered by the reconfigured wire 606.

1) A power supply system comprising: A Door Frame, A Door, A Power Transfer Unit, A Power Receive Unit, A device requiring electrical power to operate, wherein the Door Frame holds Power Transfer Unit in the proper orientation such that the distance between said Power Transfer Unit's Transmission elements is within the specified distance from an external Power Receive Unit's Receiver element when power transfer is required and the Door connected to the Door Frame providing the means to hold the Power Receive unit in the proper orientation such that the distance between said Power Receive Unit's receiver elements is within the specified distance from an external Power Transfer Unit's Transmission elements when power transfer is required and a device requiring electrical power connected to the Power Receive Unit

2) The power supply system of claim 1 further comprising: A Battery Charger, Rechargeable Battery wherein the Battery Changer coupled to the Rechargeable Battery is connected in parallel with the connection between the Power Receive Unit and the device requiring electrical power in order to supply additional power needed to operate the device requiring electrical power where said device requiring electrical exceeds the available power provided by the Power Receive Unit periodically.

3) The power supply system of claim 1 further comprising: A non-Rechargeable Battery wherein the non-Rechargeable Battery in parallel with the connection between the Power Receive Unit and the device requiring electrical power in order to supply additional power needed to operate the device requiring electrical power where said device requiring electrical exceeds the available power provided by the Power Receive Unit periodically.

4) A power supply system of claim 1 further comprising: An external power source cable wherein this external power source cable is connected to the Power Transfer Unit using the Door Frame to route said cable to the Power Transfer Unit.

5) A power supply system pf claim 1 comprising: A sleeve of the door lock mechanism wherein the Power Transfer Unit Resonator is integrated into, a bolt of the door lock mechanism wherein the Power Receive Unit Resonator is integrated into in order to transfer power between the Power Transfer Unit Resonator and Power Receive Unit Resonator

6) A power supply system pf claim 1 comprising: A strike plate of the door lock mechanism wherein the Power Transfer Unit Resonator is integrated into, a door lock mechanism wherein the Power Receive Unit Resonator is integrated into in order to transfer power between the Power Transfer Unit Resonator and Power Receive Unit Resonator

7) A power supply system pf claim 1 comprising: A typical door bell wiring scheme used in most existing houses including an AC transformer powered by house current, a pair of low voltage wiring routed to an electrical junction box centrally located in the house, a door bell push button attached to the ends of low voltage wire pair located in close proximity to the door frame is utilized as is or with slight modification to supply AC power to the Power Transfer Unit Resonator.
